(19) United States
(12) Patent Application Publication
(10) Pub. No.: US 2022/0153539 A1
(43) Pub. Date: May 19, 2022

(54) APPARATUS AND METHOD FOR GROUPING OBLONG, PREFERABLY METALLIC PRODUCTS

(71) Applicant: M.E.P. MACCHINE ELETTRONICHE PIEGATRICI S.P.A., Reana del Rojale (UD) (IT)

(72) Inventor: Giorgio DEL FABRO, Udine (IT)

(21) Appl. No.: 17/439,296

(22) PCT Filed: Mar. 11, 2020
(86) PCT No.: PCT/IT2020/050058

§ 371 Date: Sep. 14, 2021

(30) Foreign Application Priority Data
Mar. 14, 2019 (IT) 102019000003761

(51) Int. Cl. B65G 57/18; B65G 47/88

(52) U.S. Cl. CPC B65G 57/186; B65G 2201/0217; B65G 47/8815

(57) ABSTRACT

Apparatus to group together oblong products, preferably metal, comprising a sliding plane inclined with respect to a vertical plane and configured to receive a plurality of the oblong products and to allow them to slide in a direction of sliding transverse to the longitudinal development of the oblong products. Retaining elements are provided on the sliding plane.

### FIELD OF THE INVENTION

Embodiments described here concern an apparatus and a method to group together oblong products, preferably metal.

In particular, the present invention can be used to stack and align, in an automated manner and into homogeneous groups, several oblong products with the same shape, or similar or comparable shape, and to move them toward a stacking and possible binding or packaging zone, where they are bound together, or packaged, for example wrapped or packed up, in an automated manner, to be prepared for storage and/or transport.

With the term oblong products, here and in the following description, we, generally, refer to products made from oblong-shaped bars, possibly straightened, such as rods, reinforcing rods, round, square, or similar, with a circular, polygonal or flat shaped cross section. By way of example only, the oblong products as above can be medium and large brackets, straightened bars, or shaped pieces with bends on one or both ends.

### BACKGROUND OF THE INVENTION

Various cutting and bending machines are known to make brackets and/or shaped pieces starting from bundles of both straight and pre-cut bars, and also from reels of steel wire.

Starting from reels of steel wire, these machines can carry out the straightening, cutting, bending, of the wire in an automated manner by means of computerized systems, in order to define brackets and/or shaped pieces with the desired shape. These machines can, also, make simple straightened bars, which are equally as necessary in the building practice.

Known cutting and bending machines are configured to make brackets and/or shaped pieces also starting from straight bars, produced in bundles directly in the steel mill, or from bars straightened by specialized autonomous straightening and cutting machines.

In the field of production of bars, brackets and shaped pieces, hereafter called metal products for simplicity, there is the problem of their subsequent packaging.

In fact, once the quantities required for each size and type of metal products have been made, these have to be bound into homogeneous groups in order to be moved and managed.

These metal products bound into groups have to also be labeled to allow their correct storage, and so that they can be traced before, during and after shipment to the destination of use.

Currently, all these operations are performed by dedicated operators immediately downstream of the cutting and bending machine. These operators manually collect the metal products made by the machine, group them together neatly, normally bind them with iron wire, label them and put them back in a storage zone.

In the storage zone, larger bundles consisting of various types of metal products are made, always manually, grouped according to the requests of the specific client.

All this, naturally, entails a certain waste of time and a certain slowness in packaging the metal products and in all related operations, as well as safety problems for operators, who are called upon to handle very bulky and heavy metal products.

One solution of an apparatus to group together and transfer bars is described in U.S. Pat. No. 3,837,465, in which the bars to be grouped together are dropped along an inclined plane and collected in a space defined between a flat vertical wall and an abutment wall provided in rotating retaining elements. This solution is not particularly suitable for application on shaped bars with curved ends of varying sizes.

In fact, if the products made are shaped, for example if they have bent ends, or curvatures disposed longitudinally, these can cross each other and be disposed in a disorderly manner with respect to each other, creating difficulties in the subsequent packing and binding, all the more significant when the products are long and of a significant thickness.

Although in some cases a part of these operations can be carried out by anthropomorphic robotized systems which remove the metal products downstream of the cutting and bending machine by means of gripping devices, however these systems have various disadvantages.

In fact, these systems have to be carefully designed, in particular with regard to the gripping devices, they have high costs and require a technical management of the software and/or of the self-learning systems that is rather demanding, that is they require a large number of complex activities necessary to manage the very wide range of metal products that can be produced by the cutting and bending machines.

Another disadvantage is the human-machine interactions, a very critical aspect in the case of robotized systems.

Especially for safety aspects, a careful selection of the range of action of the mobile arms and of the movement range of the metal products being moved is required.

There is therefore the need to perfect an apparatus and method to group together oblong products which can overcome at least one of the disadvantages of the state of the art.

In particular, one purpose of the present invention is to provide an apparatus to group together oblong products that does not require the intervention of operators or at least makes it minimal.

Another purpose of the present invention is to provide an apparatus to group together oblong products into batches that are homogeneous by size and type in an automated manner.

Another purpose of the present invention is to provide an apparatus to group together oblong products which is simple to manage.

Another purpose is to perfect a method to group together oblong products according to the purposes described above.

The Applicant has studied, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, an apparatus to group together oblong products, preferably metal, comprises a sliding plane inclined with respect to a vertical plane and configured to receive, for example, but not necessarily, one at a time, a plurality of the oblong products and to allow them to slide in a direction of sliding transverse to the longitudinal development of the oblong products, at least due to gravity.

Retaining elements are provided on the sliding plane, configured to retain at least temporarily the oblong products as above.

In accordance with one aspect of the present invention, the sliding plane is provided with at least one step-like discontinuity cooperating with the retaining elements. Furthermore, the retaining elements are mobile in the direction of sliding to define, on each occasion with the step-like discontinuity, a zone for the temporary stacking with a variable size of the oblong products.

The presence of this step-like discontinuity causes the metal product falling along the sliding plane to position itself inside the discontinuity always with a certain orientation, preventing crossing and entanglements between bent or curved portions.

The mobility of the retaining elements in the direction of sliding allows to vary the base size of the stacking zone in order to accommodate oblong products having curvatures at the ends of any size whatsoever, even very variable.

In this way it is possible to group together a certain number of oblong products without requiring the intervention of an operator to suitably prepare the metal products for packing and binding. Thanks to this grouping together, it is then much easier to proceed with the operations, even automated, of binding, or packaging, which can be performed by specialized automated binding, wrapping and discharge means, disposed in cooperation with the apparatus.

Furthermore, this apparatus is very versatile and simple to manage since in order to group together oblong products that are homogeneous, but which for example have different sizes to those previously grouped together, it is sufficient to adjust the reciprocal distance between the retaining means and the step-like discontinuity.

Embodiments of the present invention also concern a method to group together oblong products, preferably metal.

The method provides to receive on the sliding plane, inclined with respect to a vertical plane, a plurality of the oblong products, which slide in a direction of sliding, transverse to the longitudinal development of the oblong products, at least due to the effect of gravity.

Retaining elements are provided on the sliding plane which at least temporarily retain the oblong products.

In accordance with one aspect of the present invention, the sliding plane is provided with the step-like discontinuity as above which cooperates with the retaining elements that move in the direction of sliding to define, on each occasion with the step-like discontinuity, the temporary stacking zone as above for the oblong products.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 shows a perspective view of the apparatus to group together oblong products in accordance with the present invention;

FIGS. 2-9 show an operating sequence of the functioning of the apparatus of FIG. 1;

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing the embodiments, we must, also, clarify that the present description is not limited in its application to details of the construction and disposition of the components as described in the following description using the attached drawings. The present description can provide other embodiments and can be obtained or executed in various other ways. We must, also, clarify that the phraseology and terminology used here is for the purposes of description only and cannot be considered as limitative.

Embodiments described using the attached drawings concern an apparatus to group together oblong products, indicated as a whole with reference number 10 in the attached drawings.

The apparatus 10 comprises a sliding plane 11 inclined with respect to a vertical plane and configured to receive a plurality of oblong products P and to allow them to slide in a direction of sliding D transverse to the longitudinal development of the oblong products P, at least due to the effect of gravity.

On the sliding plane 11 there are provided retaining elements 14 configured to retain the oblong products P at least temporarily.

In accordance with one aspect of the present invention, the sliding plane 11 is provided with a step-like discontinuity 15 cooperating with the retaining elements 14. The retaining elements 14 are mobile in the direction of sliding D to define, on each occasion, with the step-like discontinuity 15, a temporary stacking zone 16 for the oblong products P.

The sliding plane 11 comprises a first portion 11a, upstream of the step-like discontinuity 15 with respect to the direction of sliding D, having a feed zone 12, configured to receive one or more oblong products P, and a second portion 11b, downstream of the step-like discontinuity 15 with respect to the direction of sliding D, having a removal zone 13, in correspondence with which the oblong products P are removed by movement devices 17.

In accordance with possible embodiments, the feed zone 12 is configured to receive one or more oblong products P from a working machine located upstream. For example, the working machine can be a bending or a cutting and bending machine, a calendering machine, or other similar or comparable machines.

The removal zone 13 is positioned lower than the feed zone 12 so that the oblong products P can slide due to the effect of gravity alone.

For this purpose, the sliding plane 11 has to be inclined by such an angle as to guarantee a homogeneous sliding of the oblong products P without them being able to rise during movement from the sliding plane 11 itself. The inclination of the sliding plane 11 has to, also, take into account possible surface ridges and ribs of the oblong products P which increase their roughness and therefore the friction with the sliding plane 11.

In accordance with one aspect of the present invention, the apparatus 10 comprises a containing element 25 positioned between the feed zone 12 and the stacking zone 16 and configured to prevent the lifting and rotation of the oblong products P with respect to the sliding plane 11.

According to some embodiments, the containing element 25 faces the sliding plane 11 so that there is a space between them for the passage of the oblong products P. Especially when the oblong products P have one or more bends at the ends, the containing element 25 prevents the oblong product P, as it slides downstream, from being able to rotate on its longitudinal axis orienting the bends in an unwanted manner.

Advantageously, the containing element 25 also extends beyond the step-like discontinuity 15 so as to prevent the rotation of the oblong products P also during their fall into the stacking zone 16.

In accordance with one aspect of the present invention, the retaining elements 14 are configured to slide in guide grooves 18 parallel to the direction of sliding D in order to define, on each occasion, the size of the stacking zone 16 with respect to the step-like discontinuity 15 in the direction of sliding D.

The size of the stacking zone 16 as above is suitably increased with respect to the maximum size of the oblong products P in the direction of sliding D so that the oblong products P can fall into it in an orderly manner without any reciprocal interference.

Furthermore, the depth of the step-like discontinuity 15 is such as to allow the ordered grouping together of a number of oblong products P equal to those which are intended to make up a homogeneous batch.

In particular, the depth of the step-like discontinuity 15 causes the oblong product P that slides on the sliding plane 11, in particular along its first portion 11a, to “fall” inside the step-like discontinuity 15, orienting itself and disposing, for example, its bent ends, or the curved parts, in a manner coherent with those of the oblong products P previously discharged or subsequently discharged, forming a substantially homogeneous pack.

By depth of the step-like discontinuity 15, here and in the following we mean the difference in height between the first portion 11a of the sliding plane 11 and the second portion 11b of the sliding plane 11.

In accordance with possible solutions, the depth of the step-like discontinuity 15 can, also, be variable providing that the second portion 11b of the sliding plane 11 is mobile to increase/decrease the depth as above.

To guarantee a correct alignment of the oblong products P also in a transverse direction T, orthogonal to the direction of sliding D as above, the apparatus 10 is provided with an alignment device 24.

In accordance with the embodiment described here, the alignment device 24 comprises at least one wall 24a mobile in a transverse direction to align the oblong products P with each other with respect to the transverse direction T as above.

In accordance with possible embodiments, the alignment device 24 can comprise a pair of walls 24a facing each other and delimiting the stacking zone 16 in a transverse direction T. At least one of the walls 24a is mobile in a transverse direction T toward the other transverse wall 24a in order to align the oblong products P with each other with respect to the transverse direction T as above.

The alignment device 24 is, also, provided with at least one movement member 24b for activating/deactivating the at least one mobile wall 24a. Advantageously, the movement member 24b can have a fixed, possibly adjustable, travel or it can provide devices to measure pressure and/or force that indicate when the action of alignment can be considered finished.

In accordance with the embodiments described here, the guide grooves 18 extend starting from the step-like discontinuity 15 at least up to the removal zone 13, so that the retaining elements 15 can slide on the sliding plane 11, in this case on its second portion 11b, for almost its entire extension with respect to the direction of sliding D.

The retaining elements 14 are configured, sliding on the guide grooves 18 as above, to accompany the oblong products P, previously grouped together in the stacking zone 16, toward the removal zone 13 to be moved with the movement devices 17 as above.

During their movement, the oblong products P are constantly resting, due to the effect of gravity, on the retaining elements 14 and are accompanied by them which substantially regulate their speed.

The retaining elements 14 are configured to slide in a coordinated manner along the respective guide grooves 18 so that the oblong products P, grouped together in an orderly manner, continue toward the removal zone 13 without becoming misaligned. For this purpose, the retaining elements 14 are aligned in the transverse direction T orthogonal to the direction of sliding D.

In the event the size of the oblong products P is larger or smaller than the transverse direction T, it is possible to provide the use of only some retaining elements 14 or of all of them, and provide that the possible remaining retaining elements 14 are positioned, for example, in correspondence with the removal zone 13, beyond the movement devices 17.

The retaining elements 14 rise from the sliding plane 11, in this case from the second portion 11b, advantageously in an orthogonal direction so as to act as an abutment for the oblong products P which fall in order into the stacking zone 16.

The retaining elements 14 are suitable to house inside them striker pins 19 sliding between an internal position, in which they are completely contained inside the retaining elements 14, and an operating position, in which they protrude from the retaining elements 14 to increase their height from the second portion 11b of the sliding plane 11.

In this way it is possible to prevent the oblong products P from being able to go, during their orderly fall into the stacking zone 16, or during their sliding toward the removal zone 13, beyond the retaining elements 14 and fall from the sliding plane 11.

In accordance with possible solutions, the retaining elements 14 can comprise a plurality of walls that have an extension in the transverse direction T, a plurality of cylinders suitably distanced in the transverse direction T or other possible elements able to perform the same function.

In the event the retaining elements 14 comprise the walls as above, these are distanced from each other in the transverse direction T by an interspace 22 aligned with the respective movement device 17 located downstream. In this way the retaining elements 14 are suitable to slide beyond the movement devices 17, advantageously between them, in the direction of sliding D in order to cooperate with the latter as will be described in more detail below.

In correspondence with the removal zone 13, the movement devices 17 as above are suitable to temporarily accommodate the oblong products P and to lift them from the sliding plane 11, in this case from its second portion 11b.

For this purpose, the movement devices 17 are configured to pass from an operating position in which they lift the oblong products P from the sliding plane 11, in particular from its second portion 11b, in which they are positioned above the second portion 11b, in order to lift the oblong products P with respect to the sliding plane 11, to a position of non-interference, in which they are positioned partly below the sliding plane 11.

The second portion 11b of the sliding plane 11 is provided with apertures 20 mating with the shape of the movement devices 17 to allow them to pass from the lifting operating position as above to the position of non-interference.

In accordance with possible embodiments of the present invention, each movement device 17 has a concave conformation with a concavity open upwards to receive the oblong products P accompanied by the retaining elements 14.

The retaining elements 14, being configured to slide further downstream than the position of the movement devices 17, are suitable to transfer on the latter, by interference, the oblong products P previously grouped together.

To facilitate this operation, each movement device 17 is provided with an interference portion 17a configured to stop the oblong products P, accompanied by the retaining elements 14, and with a containing portion 17b configured to accommodate the oblong products P just stopped by each interference portion 17a.

In particular, in the position of non-interference of the movement means 17, the interference portion 17a as above exits from the sliding plane 11 to stop the oblong products P.

In accordance with the embodiments described here, the apparatus 10 is provided, in correspondence with the removal zone 13, with a binding unit 21 configured to bind the oblong products P disposed on the movement units 17 at least when the movement units 17 are in the operating position as above.

It is within the scope of the invention that the binding unit 21 can be replaced by an automated unit for winding with a suitable material, to form a pack of wound products ready for removal from the apparatus 10.

In accordance with the embodiments described here, the apparatus 10, also, comprises at least one mobile drawer 23 positioned in correspondence with the removal zone 13 and configured to cooperate with the movement devices 17 in lifting the oblong products P.

Advantageously, the apparatus 10 comprises two mobile drawers 23 aligned with the movement devices 17 and positioned at the respective ends of the sliding plane 11, in this specific case of the second portion 11b, with respect to the transverse direction T.

Each mobile drawer 23 is configured to accommodate the ends of the oblong products P which may or may not have one or more bends. In this way, these ends always remain parallel to the sliding plane 11 even during their lifting, by means of the movement devices 17, so that they do not rotate with respect to the remaining portions parallel to the transverse direction T and do not become disordered.

A lifting unit 24 is associated with the mobile drawer 23 which allows it to be moved in a coordinated or non-coordinated manner with the movement of the movement devices 17.

The attached drawings also show support elements 26 of the blade type, which are activated selectively to support the oblong products P before or after the execution of the bends, when the oblong products P are released by the grip of the bending members.

Embodiments of the present invention, also, concern a method to group together oblong products, preferably metal.

The method provides to receive on the sliding plane 11, inclined with respect to a vertical plane, a plurality of oblong products P, which slide in the direction of sliding D, transverse to the longitudinal development of the oblong products P, at least due to the effect of gravity. On the second portion 11b of the sliding plane 11 there are provided the retaining elements 14 that at least temporarily retain the oblong products P.

In accordance with one aspect of the present invention, the sliding plane 11 is provided with the step-like discontinuity 15 which cooperates with the retaining elements 14 which move in the direction of sliding D to define, on each occasion with the step-like discontinuity 15, the temporary stacking zone 16 as above for the oblong products P.

In accordance with one aspect of the present invention, the method provides a step of binding, or wrapping with suitable wrapping material, the oblong products P with a binding unit 21 positioned downstream of the stacking zone 16.

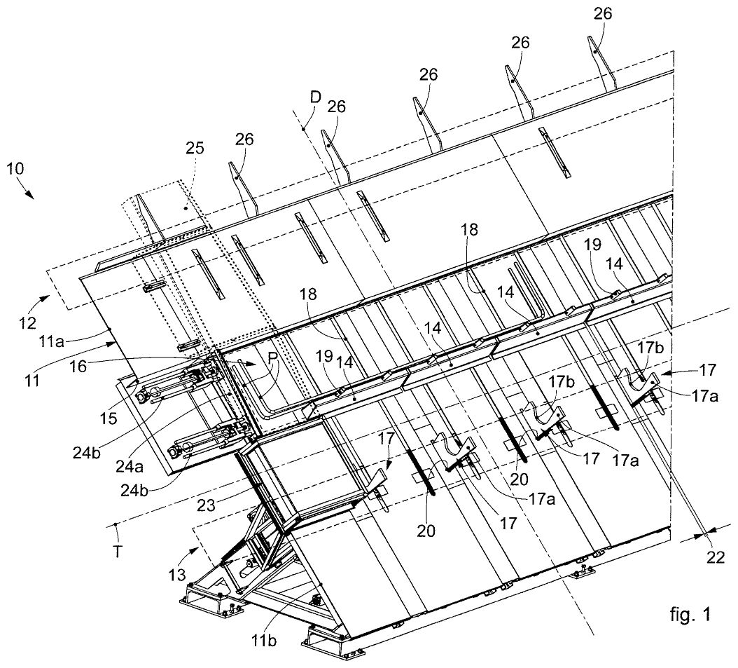

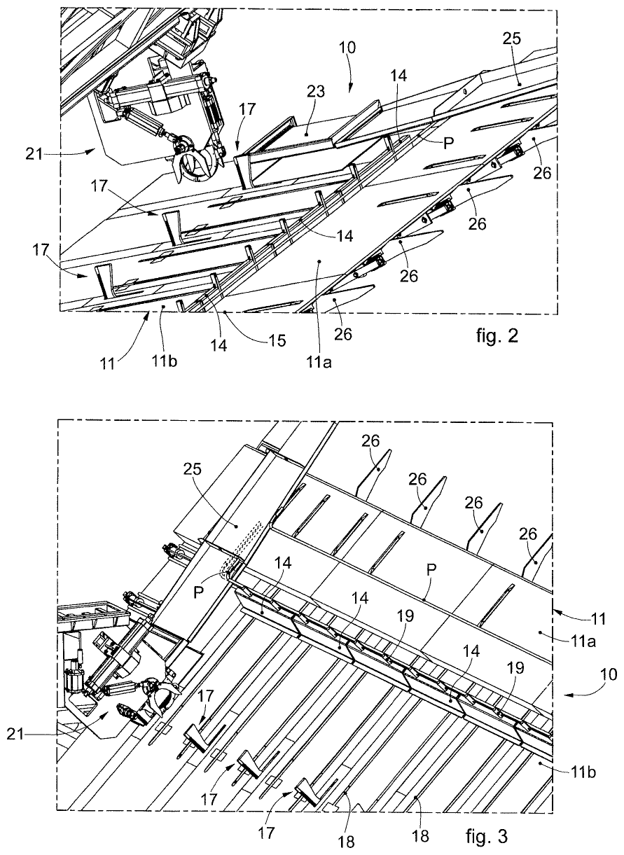

With reference to FIGS. 2-9 a possible operating sequence of the functioning of the apparatus in FIG. 1 is shown.

If there is a need to group together and package into batches oblong products P of a certain type, for example coming from a bending machine located upstream of the apparatus 10, the position of the retaining means 14 is suitably adjusted in the direction of sliding D in order to define the correct size, in the same direction, of the stacking zone 16, FIG. 2.

The striker pins may or may not be taken to the operating position as above to increase the height of the retaining means 14 from the second portion 11b of the sliding plane 11, and make the sliding of the oblong products P more effective and safer.

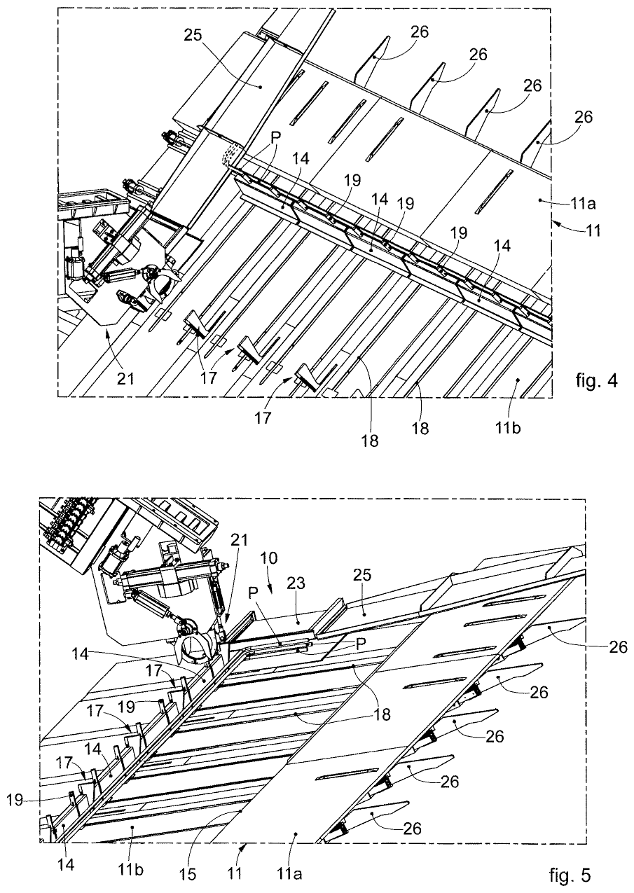

Subsequently, as shown in FIGS. 3-4 at least one oblong product P at a time is positioned in correspondence with the feed zone 12 of the sliding plane 11, in this specific case of the first portion 11a. Due to the effect of gravity, the oblong product P slides along the first portion 11a of the sliding plane 11, until reaching the step-like discontinuity 15.

The oblong product P, then, falls beyond the step-like discontinuity 15 continuing its slide along the second portion 11b of the sliding plane 11, until it meets the opposition of the retaining means 14 which block its travel and allow an orderly stacking thereof at least in the direction of sliding D.

In the same way, one oblong product P after the other is grouped together with the previous ones until the number required for packaging that particular batch is reached.

To ensure a correct alignment of the oblong products P processed, the alignment device 24 is activated. For this purpose, the mobile wall 24a, or possibly the mobile walls 24a, translates, or translate, toward the other in a transverse direction T thrusting the ends of the oblong products P until the desired alignment is obtained.

As shown in FIG. 5, once the grouping and alignment has been completed, the retaining means 14 slide on the guide grooves 18 accompanying the oblong products P as above toward the removal zone 13.

The movement devices 17 are in the position of non-interference as above so that only the interference portion 17a of each movement mean 17 is exiting from the second portion 11b of the sliding plane 11.

The sliding means 14 slide on the guide grooves 18 until they go past the movement devices 17, in this way the oblong products P are clamped by interference by the interference portions 17a as above.

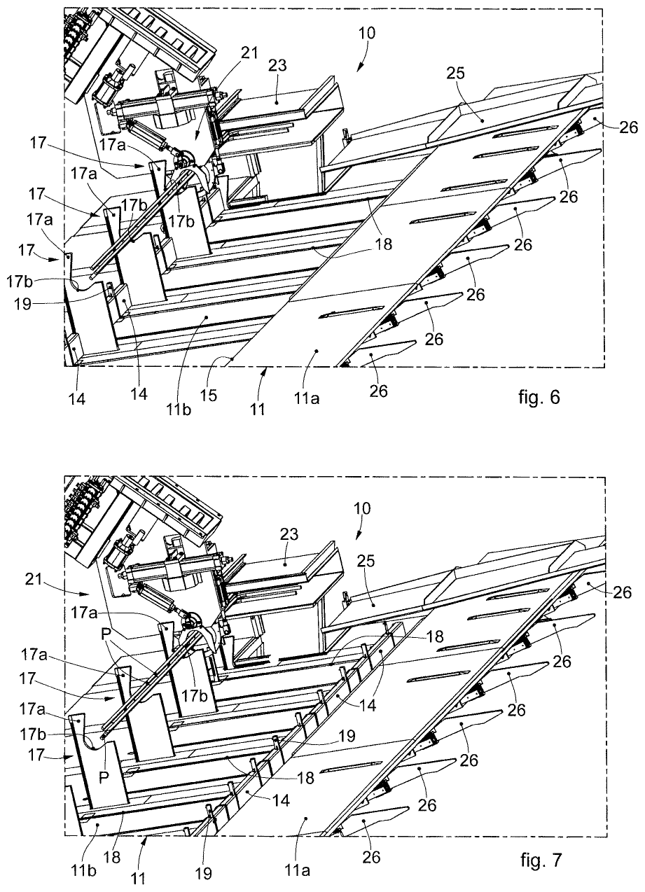

Subsequently, as shown in FIG. 6, the movement means 17 are taken from the position of non-interference to the operating position as above. During their lifting, the oblong products P, clamped by the interference portions 17a, settle in the containing portions 17b of the retaining means 17 which support them at least until the end of the subsequent binding operation.

During the lifting of the oblong products P, it is possible to provide that at least their ends are supported by the mobile drawers 23.

When the movement means 17 are taken from the position of non-interference to the operating position, the retaining devices 14 are taken back into the desired position in order to redefine the correct size of the stacking zone 16 for the grouping together of other oblong products P, FIG. 7.

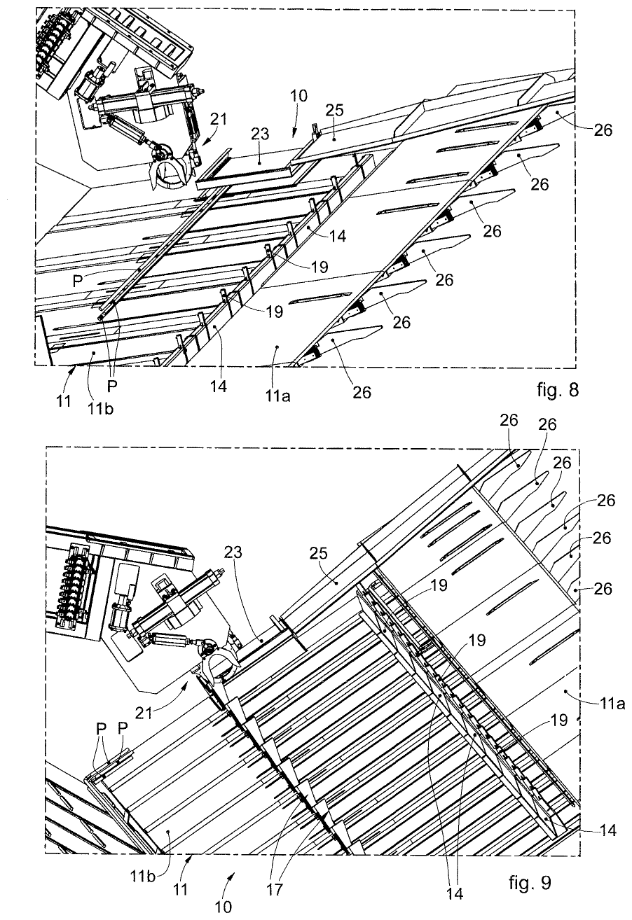

As shown in FIGS. 8-9, at the end of the binding operation, which is carried out by the binding unit 21, the oblong products P can be removed and moved by means of a bridge crane, or they can be repositioned on the second portion of the sliding plane 11, in order to slide downstream toward other transport means. In this case, the movement means 17 are taken into the position of non-interference so that the interference portions 17a are also below the plane of the second portion 11b of the sliding plane 11.

In accordance with possible solutions, if there is a need to group together oblong products P that have a very large extension in the transverse direction T, the retaining elements 14 can be positioned immediately close to the step-like discontinuity 15 with the striker pins 19 in an internal position. In this way the oblong products P fall beyond the step-like discontinuity 15 and their sliding downstream is stopped directly by the interference portions 17a of the movement devices 17.

It is clear that modifications and/or additions of parts or steps may be made to the apparatus to group together oblong products and to the corresponding method as described heretofore, without departing from the field of the present invention as defined by the claims.

It is also clear that, although the present invention has been described with reference to some specific examples, a person of skill in the art shall certainly be able to achieve many other equivalent forms of an apparatus to group together oblong products and of the corresponding method, having the characteristics as set forth in the claims and hence all coming within the field of protection defined thereby.

In the following claims, the sole purpose of the references in brackets is to facilitate reading and they must not be considered as restrictive factors with regard to the field of protection claimed in the specific claims.

1-12. (canceled)

13. Apparatus to group together oblong products, preferably metal, comprising a sliding plane inclined with respect to a vertical plane, said sliding plane having a first portion configured to receive a plurality of said oblong products, and to allow them to slide by gravity in a direction of sliding transverse to the longitudinal development of said oblong products, movable retaining elements being provided on said sliding plane, wherein said sliding plane is provided with a step-like discontinuity cooperating with said retaining elements, in which said retaining elements are sliding along a second portion of said sliding plane, disposed downstream said step-like discontinuity, in said direction of sliding to define, on each occasion with said step-like discontinuity, a zone for the temporary stacking of said oblong products that fall inside said step-like discontinuity, wherein a depth of the step-like discontinuity is defined by the difference in height between the first portion of the sliding plane and the second portion of said sliding plane.

14. Apparatus as in claim 13, wherein said first portion, disposed upstream of the step-like discontinuity with respect to the direction of sliding, has a feed zone, configured to receive one or more oblong products, and said second portion, disposed downstream of the step-like discontinuity with respect to the direction of sliding, has a removal zone, in correspondence with which the oblong products are able to be removed by movement devices.

15. Apparatus as in claim 14, further comprising guide grooves parallel to the direction of sliding, said retaining elements being mobile in said guide grooves to define, on each occasion, the size of the stacking zone with respect to the step-like discontinuity in the direction of sliding.

16. Apparatus as in claim 15, wherein said retaining elements are configured, sliding in said guide grooves, to accompany the oblong products, previously grouped in the stacking zone, toward said removal zone.

17. Apparatus as in claim 16, further comprising striker pins, disposed inside said retaining elements, sliding between an internal position, in which they are completely contained inside said retaining elements, and an operating position, in which they protrude from said retaining elements to increase their height from said second portion of the sliding plane.

18. Apparatus as claim 14, wherein said movement devices have an operating position, in which they are positioned above said second portion of the sliding plane, to lift the oblong products from the second portion, and a position of non-interference, in which they are positioned at least partly below the second portion of the sliding plane.

19. Apparatus as in claim 18, wherein each movement device is provided with an interference portion configured to stop the oblong products, accompanied by the retaining elements, and with a containing portion configured to accommodate the oblong products just stopped by each interference portion.

20. Apparatus as in claim 13, wherein it is provided with an alignment device to guarantee a correct alignment of the oblong products also in a transverse direction, orthogonal to said direction of sliding, wherein the alignment device comprise at least one wall delimiting the stacking zone in the transverse direction.

21. Apparatus as in claim 13, further comprising a containing element positioned between the feed zone and the stacking zone and configured to prevent the lifting and rotation of the oblong products with respect to the sliding plane.

22. Apparatus as in claim 13, wherein it is provided with a binding unit, or a wrapping unit with a suitable wrapping material, positioned in correspondence with said removal zone and configured to bind together, or wrap, the oblong products disposed on said movement units at least when said movement units are in the said operating position.

23. Method to group together oblong products, preferably metal, using an apparatus as in claim 13, which provides to receive on a sliding plane, inclined with respect to a vertical plane, a plurality of said oblong products, said oblong products sliding in a direction of sliding, transverse to the longitudinal development of said oblong products, at least due to the effect of gravity, and on said sliding plane retaining elements being provided which at least temporarily retain said oblong products, wherein the oblong products are slid by gravity on said sliding plane and are dropped inside a step-like discontinuity provided along said sliding plane and defined together with said retaining elements which move in said direction of sliding to define, on each occasion with said step-like discontinuity, a temporary stacking zone for said oblong products.

24. Method as in claim 23, further comprising a step of binding said oblong products with a binding unit, or wrapping unit, positioned downstream of said stacking zone.

25. Apparatus as in claim 13, further comprising guide grooves parallel to the direction of sliding, said retaining elements being mobile in said guide grooves to define, on each occasion, the size of the stacking zone with respect to the step-like discontinuity in the direction of sliding.

26. Apparatus as claim 15, wherein said movement devices have an operating position, in which they are positioned above said second portion of the sliding plane, to lift the oblong products from the second portion, and a position of non-interference, in which they are positioned at least partly below the second portion of the sliding plane.

27. Apparatus as claim 16, wherein said movement devices have an operating position, in which they are positioned above said second portion of the sliding plane, to lift the oblong products from the second portion, and a position of non-interference, in which they are positioned at least partly below the second portion of the sliding plane.

28. Apparatus as claim 17, wherein said movement devices have an operating position, in which they are positioned above said second portion of the sliding plane, to lift the oblong products from the second portion, and a position of non-interference, in which they are positioned at least partly below the second portion of the sliding plane.

29. Apparatus as claim 25, wherein said movement devices have an operating position, in which they are positioned above said second portion of the sliding plane, to lift the oblong products from the second portion, and a position of non-interference, in which they are positioned at least partly below the second portion of the sliding plane.
